(19) United States
(12) Patent Application Publication
(10) Pub. No.: US 2018/0163917 A1
(43) Pub. Date: Jun. 14, 2018

(54) Locking Computer Stand

(71) Applicant: Giros Design, San Ramon, CA (US)

(72) Inventor: Gururaj Govindasamy, San Ramon, CA (US)

(73) Assignee: Giros Design, San Ramon, CA (US)

(21) Appl. No.: 15/375,081

(22) Filed: Dec. 9, 2016

(51) Int. Cl. F16M 11/08; F16M 11/22; G06F 1/18

(52) U.S. Cl. CPC F16M 11/08; G06F 1/181; F16M 11/22

(57) ABSTRACT

A stand for holding a desktop computer includes a base, a platter mounted for rotation to the base, an arm extending upwardly from the base, and a clip releasably secured to the arm. The computer, having a back with an upstanding lip forming a pocket between the lip and the back, is received on the platter. The clip has a catch that extends downward along the arm, defining a space above the platter between the arm and the clip, and which overlaps the lip of the desktop computer, receives the pocket between the clip and the arm, and clamps the bottom of the computer against the platter.

### FIELD OF THE INVENTION

The present invention relates generally to accessories for desktop computers, and more particularly to locking devices for computers.

### BACKGROUND OF THE INVENTION

Personal computers, such as laptop and desktop computers, are a ubiquitous and important part of our daily lives. Such computers are extremely valuable to their owners, not only because they can be very expensive but also because they usually store sensitive information. Users regularly save work or school documents on their computers, as well as personal information ranging from photo albums and email accounts to bank account and credit card information. Since computers are so valuable, securing them is paramount. Preventing theft of the computer itself is one aspect of this security.

The small size of modern desktop computers subjects them to an increased danger of being stolen. Once a thief has physical access to the location of the computer, all he must usually do is unplug a few cable connections and carry the computer away, which can be done in a matter of seconds. As such, owners often desire to lock their computers to secure or heavy objects such as a desk. Some computers have a hole or bracket which allows a cable lock to be locked directly into the computer. Disadvantageously, this requires manufacturing of computers to accommodate a specific style and size of cable lock. In addition, the cable lock provides no other advantages or functions beyond simply securing the computer in the environment. An improved system for locking a computer that can accommodate different styles of cable locks and provide additional advantages is needed.

### SUMMARY OF THE INVENTION

A stand for holding a desktop computer includes a base, a platter mounted for rotation to the base, an arm extending upwardly from the base, and a clip releasably secured to the arm. The computer, having a back with an upstanding lip forming a pocket between the lip and the back, is received on the platter. The clip has a catch that extends downward along the arm, defining a space above the platter between the arm and the clip, and which overlaps the lip of the desktop computer, receives the pocket between the clip and the arm, and clamps the bottom of the computer against the platter.

The above provides the reader with a very brief summary of the detailed description presented below, and is not intended to limit or define in any way the scope of the invention or key aspects thereof. Rather, this brief summary merely introduces the reader to some aspects of the invention in preparation for the detailed description that follows.

### BRIEF DESCRIPTION OF THE DRAWINGS

Referring to the drawings:

FIG. 1 is a top perspective view of a locking computer stand;

FIGS. 2A and 2B are exploded top and bottom perspective views, respectively, of the locking computer stand of FIG. 1;

FIG. 3 is a side elevation view of the locking computer stand of FIG. 1;

FIG. 4 is a rear perspective view of a desktop computer on the locking computer stand of FIG. 1;

FIG. 5A is a section view taken along the line 5-5 in FIG. 4;

FIG. 5B is an enlarged view of a portion of FIG. 5A;

FIG. 6A is a top perspective view of an alternate embodiment of a locking computer stand;

FIG. 6B is an exploded bottom perspective view of the locking computer stand of FIG. 6A;

FIG. 7 is a section view taken along the line 7-7 in FIG. 6A with a computer on the locking computer stand of FIG. 6A;

FIG. 8 is a top perspective view of an alternate embodiment of a locking computer stand;

FIG. 9 is an exploded bottom perspective view of the locking computer stand of FIG. 8;

FIG. 10 is an enlarged section view taken along the line 10-10 in FIG. 8 with a computer on the locking computer stand of FIG. 8;

FIG. 11A is a top perspective view of an alternate embodiment of a locking computer stand;

FIG. 11B is an exploded bottom perspective view of the locking computer stand of FIG. 11A; and

FIG. 12 is an enlarged section view taken along the line 12-12 in FIG. 11A with a computer on the locking computer stand of FIG. 11A.

### DETAILED DESCRIPTION

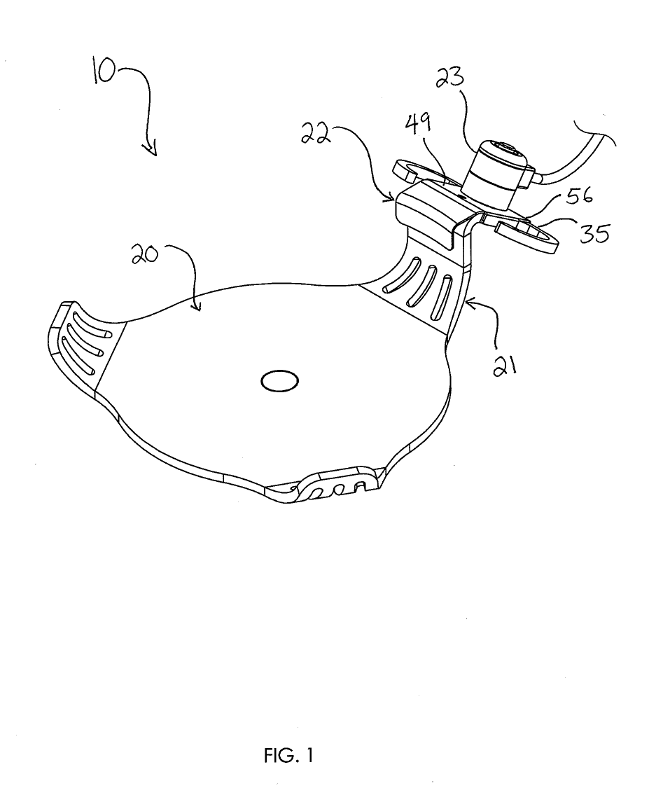

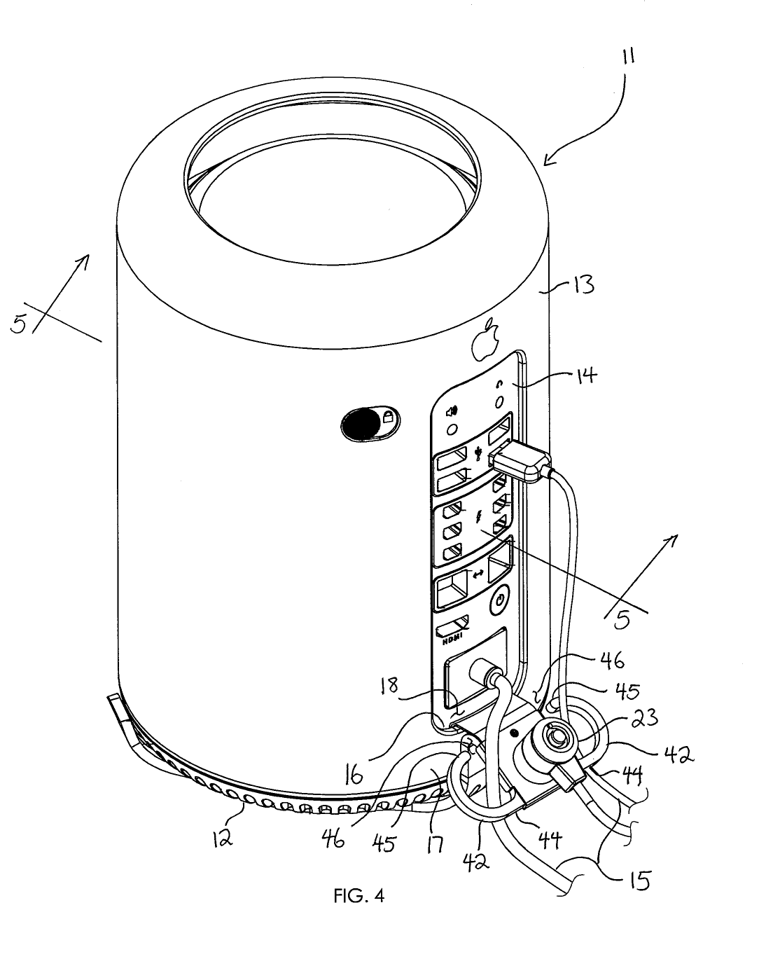

Reference now is made to the drawings, in which the same reference characters are used throughout the different figures to designate the same elements. FIG. 1 is a perspective view of a locking computer stand 10 (“stand 10”) useful for holding a desktop computer. The stand 10 centers, supports, and secures a desktop computer having a particular construction. Such computers, as shown in FIG. 4, have a lip and a gap or pocket formed near the back to which the stand 10 is secured. Briefly, FIG. 4 illustrates a computer 11 which is exemplary of a type of computer that can be held by the stand 10. The computer 11 is a cylindrical tower approximately ten inches tall and seven inches in diameter that rests on a flat bottom 12. The computer 11 includes a cylindrical outer housing 13 and an exposed back panel 14 with ports to which data communication cables 15 are connected. The back panel 14 is recessed and exposed within the outer housing 13 of the computer 11 such that the outer housing 13 forms a thin lip 16 around the back panel 14. A bottom 17 of the lip 16 is spaced apart vertically from the bottom 12 of the computer 11. The bottom 17 of the lip 16 is also spaced apart horizontally from the back panel 14 to form a narrow, upwardly-opening pocket 18 between the lip 16 and the back panel 14. Computers such as these are suitable for use with the stand 10, and one having ordinary skill in the art will readily appreciate that a computer with a flat bottom and a lip spaced slightly apart from the back so as to form a pocket will be useful with the stand 10 described herein, regardless of the design of the rest of the housing.

Returning to FIG. 1, the stand 10 includes a platter 20, an arm 21 extending upwardly from the platter 20, and a clip 22 releasably secured to the arm 21. When secured to the arm 21, the clip 22 projects outwardly over the arm, to overlap the lip 16 of the computer 11. The clip 22 is releasably locked to the arm 21 by a key-operated cable lock 23. Thus, the computer 11 may be held securely between the clip 22 and the platter 20, and the cable lock 23 may then be secured to a heavy or stable object in the environment, such as a desk or a wall bracket, to prevent the computer 11 from being carried away. Therefore, the stand 10 is useful for discouraging and preventing theft of a computer.

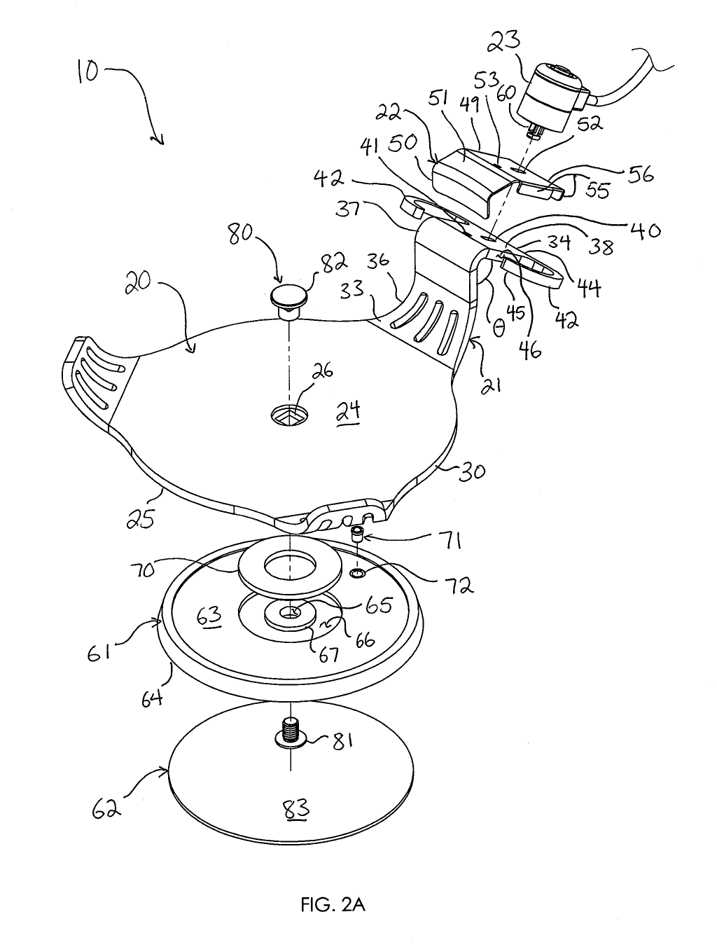

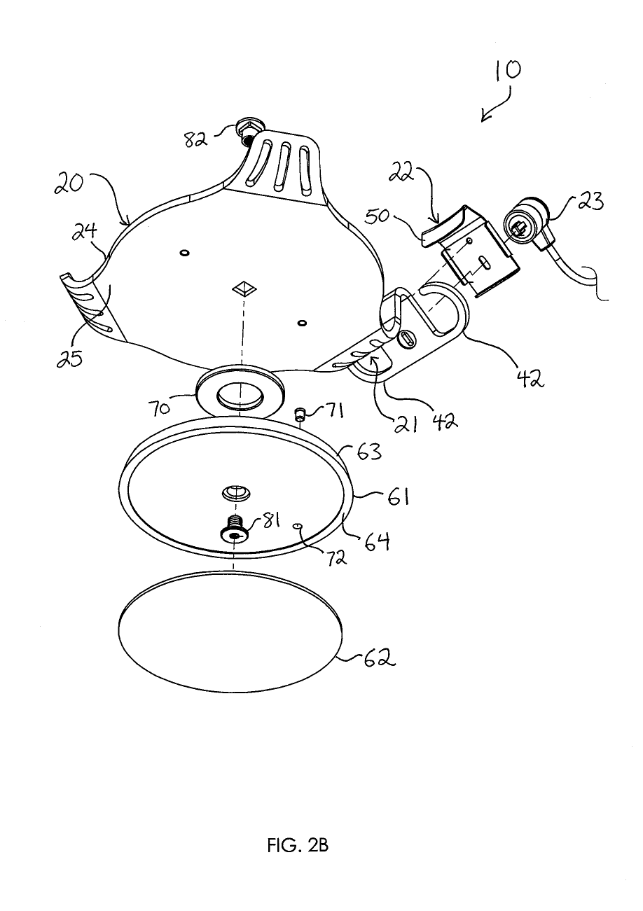

Reference now is made to FIG. 2A, which is a top perspective, exploded view of the stand 10. The platter 20 is a thin, generally disc-like structure constructed of a material or combination of materials having characteristics of strength and rigidity, such as aluminum, other metal, or plastic. The platter 20 has a flat, smooth upper surface 24 for receiving and supporting the bottom 12 of the computer 11 thereon. Opposite the upper surface 24, the platter 20 has a flat, smooth lower surface 25 (seen in FIG. 2B) which is coextensive with the upper surface 24. A continuous outer edge 30 of the platter 20 extends around the platter 20 between the upper and lower surfaces 24 and 25. The outer edge 30 is generally circular for most of its length, interrupted only by the arm 21 and two wings 31, spaced generally evenly around the outer edge 30. The arm 21 and the wings 31 each extend from the outer edge 30 of the platter 20. The arm 21 and wings 31 cooperate to provide a user with guidance when centrally positioning the computer 11 on the platter 20, and also allow the user to more easily grasp, manipulate, and rotate the platter 20. A hole 26 extends centrally through the platter 20 from the upper surface 24 to the lower surface 25. The hole 26 is a hold for a rotation hub allowing the platter 20 to be mounted for rotational movement on a base 61, as described in detail below.

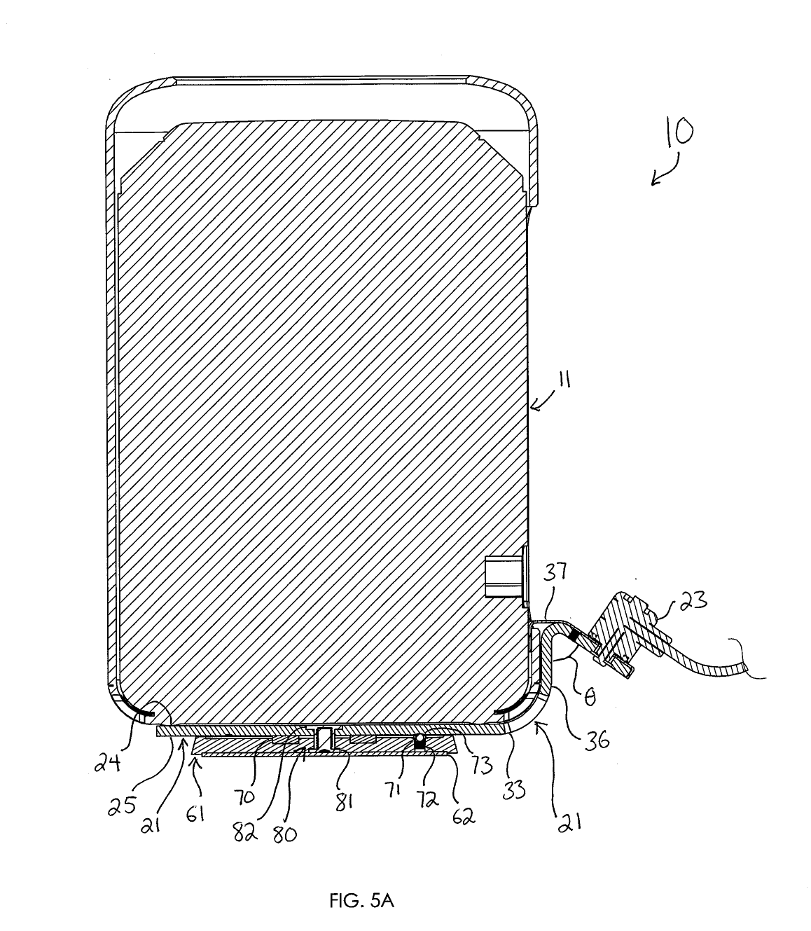

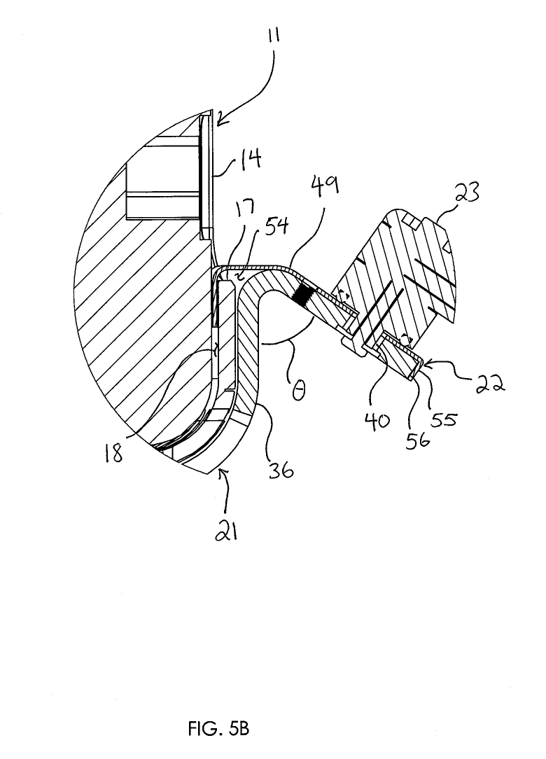

Referring to FIG. 2A still, the arm 21 extends upwardly from an end 33, located at the outer edge 30 of the platter 20, to an opposed end 34 at which a mount 35 is located on the arm 21. At the end 22, the arm 21 is formed monolithically and integrally with the platter 20. Like the platter 20, the arm 21 is constructed of a strong, rigid material such as aluminum or another metal. In other embodiments, the arm 21 is permanently coupled to the platter 20 with alternate fastening methods such as welding or gluing. The arm 21 includes a lower portion 36 proximate the end 33, and a bend portion 37 proximate the end 34. The lower portion 36 is curved proximate to the end 33 and is straight proximate a location intermediate the lower and bend portions 36 and 37, such that lower portion 36 has a semi-concave or roughly “J” shape. This shape of the lower portion 36 of the arm 21 closely fits the contour of the computer 11, as illustrated in the section view of FIG. 5A, so that the computer 11 fits snugly along the arm 21 when received on the platter 20. The bend portion of the arm 21 extends from the lower portion 36 radially outward, with respect to the platter 20, and downward at an angle relative to the lower portion 36, so as to form an acute angle θ with the lower portion 36 (shown most clearly in FIG. 5B). The angle θ of the bend portion 37 relative to the lower portion 36 orients the bend portion 37 of the arm 21 diagonally away from the computer 11, thereby exposing the mount 35 of the bend portion 37 away from the computer 11. This provides a user with relatively unobstructed access to the mount 35 on the bend portion 37 to conveniently apply a cable lock therethrough.

Still referring to FIG. 2A, the mount 35 of the bend portion 37 has a flat, generally rectangular upper surface 38 with two holes 40 and 41 formed through the mount 35 generally perpendicular to the upper surface 38. The holes 40 and 41 are located medially on the mount 35 and are spaced apart from each other. The holes 40 and 41 are oblong and circular in shape, respectively, only a few millimeters in diameter each, and different sizes to accommodate different styles of cable locks.

Two guide loops 42 are also carried on the arm 21, opposed from one another across the mount 35 and in a common horizontal plane as each other and the mount 35. The guide loops 42 are severed annuli: each has an attached end 44 that is formed integrally and monolithically to the mount 35 at the end 34 of the arm 21. From the end 44, each guide loop 42 is a roughly “C”-shaped body that extends arcuately to terminate in an opposed free end 45 proximate a front of the mount 35. The free end 45 of the guide loop 42 is not coupled to any structure and thus defines a small opening 46 between the free end 45 and the arm 21 through which the cables 15 attached to the computer 11 are applied into the loops 42, as shown in FIG. 4 for capture therein. The loops maintain organization among the cables 15 and direct them straight off of the back panel 14 of the computer 11, and carry the cables 15 with the computer 11 during rotation of the platter 20 on the base 61.

Still referring to FIG. 2A, the clip 22 is a bracket uniquely structured to correspond to the mount 35 for releasably coupling thereto so as to form a latch for securing the computer on the stand 10. The clip 22 includes a rectangular upper portion 49 and an opposed lower portion defining a catch 50 that extends outwardly and downwardly from the upper portion 49. The upper portion 49 is slightly bent at a bend 51 that extends transversely across the upper portion 49, which bend 51 thusly disposes the catch 50 outwardly and downwardly from the upper portion 49. The upper portion 49 has a size and shape similar to that of the mount 35 of the arm 21 such that it can be received in flush contact against the upper surface 38 of the mount 35 so that it is useful for securing the computer 11 on the platter 20. The catch 50 extends at a right angle to the bend 51 at a distal end of the upper portion 49. The angle between the catch 50 and the upper portion 49, and the bent configuration of the upper portion 49, orient the catch 50 down toward the platter 20 when the clip 22 is received on the mount 35. The catch 50 is thus spaced horizontally apart from the arm 21 and vertically above the platter 20, and thereby overhangs the arm 21 when received thereon. This allows the catch 50 to overlap the lip 16 on the back of the computer 11 when the computer 11 is carried on the platter 20.

The upper portion 49 also includes holes 52 and 53 that correspond in size, shape, and location to the holes 40 and 41 of the arm 21. The holes 52 and 53 are located medially on the upper portion 49 of the clip 22 and are spaced apart from each other. The holes 52 and 53 are oblong and circular in shape, respectively, and are only a few millimeters in diameter.

Turning now to FIGS. 1, 2A, and 2B, when the clip 22 is received on the arm 21, the upper portion 49 of the clip 22 is flush against the mount 35. Three tabs 55 extend downwardly from the clip 22 to frame the upper portion 36 of the arm 21 and prevent relative lateral movement of the clip 22 with respect to the mount 35. The clip 22 is constructed of a strong, hard, rigid material such as aluminum or steel, and so the tabs 55 securely hold the clip 22 on the mount 35 and resist unauthorized access, movement, and prying. One of the tabs 55 extends from an end 56 of the clip 22 opposite the catch 50. The other two of the tabs 55 are identical to each other and extend from opposed sides of the clip 22 between the end 56 and the catch 50, such that they flank the mount 35 on either side thereof. When so received, the holes 52 and 53 in the clip 22 are aligned with the holes 40 and 41 in the arm 21, respectively. The holes 40 and 52 align to form a channel or keyway through which a pin 60 of the cable lock 23 is inserted, allowing the clip 22 to be locked into the arm 21.

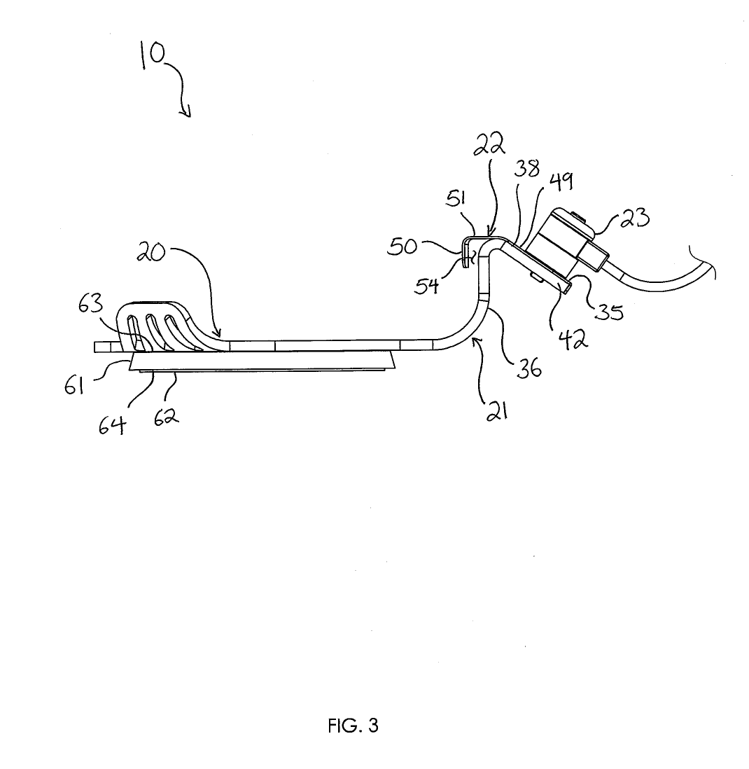

Referring now to FIG. 3, the catch 50 is spaced apart horizontally from the arm 21, held in an elevated position with respect to the platter 20, and extends downward toward the platter 20, thereby defining a narrow space 54 between the catch 50 and the lower portion 36 of the arm 21. The space 54 is bounded from above by the upper portion 49 of the clip 22, and is open from below. As such, the space 54 is configured to receive the bottom 17 of the lip 16 of the computer 11 with the catch 50 extending into the pocket 18, when the computer 11 is carried in the stand 10.

The platter 20 is mounted for rotational movement on a base 61 having a foot 62, as shown in FIG. 2B and FIG. 3. This allows the user to access the back panel 14 of the computer 11 easily by rotating the platter 20 and the computer 10 together. The base 61 is a thin, disk-like structure with a smooth, flat upper surface 63 and an opposed smooth and flat lower surface 64. Referring now also to FIG. 2A, the base 61 includes a central hole 65 formed entirely therethrough, which hole 65 is registered with the hole 26 in the platter 20 to receive a fastener for coupling the platter 20 to the base 61. Coaxial to, and encircling the hole 65, the upper surface 63 has an annular cavity 66 recessed into the upper surface 63. A coaxial, upstanding lip 67 is within the cavity 66, surrounding and defining the hole 65. The cavity 66 loosely receives a washer 70 around the lip 67 which corresponds in size and shape to the cavity 66. The washer 70 projects just slightly above the upper surface 63 of the base 61, and as such, provides a bearing surface between the upper surface 63 of the base 61 and the lower surface 25 of the platter 20. The base 61 is preferably one-piece, and formed out of a material or combination of materials having characteristics of rigidity and durability, such as plastic.

Referring to FIGS. 2A, 2B, and 5A, the base 61 includes a spring detent 71 applied to a small cylindrical socket 72 in the upper surface 63. Like the washer 70, the spring detent 71 also protrudes just slightly above the upper surface 63 of the base 61 so that it is in contact with the lower surface 25 of the platter 20 when the platter 20 is mounted on the base 61. A small, semi-spherical socket 73 is formed upwardly into the lower surface 25 of the platter 20 and is radially offset from the hole 26 in the platter 20 by the same distance that the socket 72 is radially offset from the hole 65 in the base 61. As such, the spring detent is radially aligned with the socket 73, and locks into the socket 73 when the platter 20 is rotated to place the socket 73 in alignment with the spring detent 71. The force of the spring detent is overcome by applying a sufficient amount of rotational force on the platter 20 with respect to the base 61, which causes the spring detent 71 to recede out of the socket 73 and into the socket 72.

Referring to FIGS. 2A, 2B, and 5A, a hub 80 couples the platter 20 to the base 61 for rotation of the platter 20 with respect to the base 61. The hub 80 includes a threaded bolt 81 and a cap 82 threadably received on the bolt 81. The hub 80 fits through the hole 26 in the platter 20 with the cap 82 snug-fit into the hole 26. The hole 26 is formed with a square interior, which corresponds to a square shoulder just below a head of the cap 82, so that the cap 82 is prevented from rotation with respect to the hole 26 and platter 20. The cap 82 is flush with the upper surface 24 of the platter 20 so that it does not interfere with the computer 11 placed atop the platter 20. The bolt 81, received in the lower surface 72, has an enlarged head and is threaded into the cap 82, thereby binding the bolt 81 and cap 82, together with the base 61 and washer 70 disposed therebetween. The lower surface 25 of the platter 20 opposes the upper surface 63 of the base 61 and is spaced just apart therefrom by the washer 70. The platter 20 rotates on the base 61, the washer 70 reduces the friction between the platter 20 and the base 61, and the spring detent 71 helps prevent accidental rotation of the platter 20 with respect to the base 61.

The foot 62 is a thin, disk-like structure preferably constructed of a non-slip material such as plastic or rubber, which prevents the foot 62 from sliding on a surface. The foot 62 has an adhesive upper face 83, which is placed against and adhered to the lower surface 72 of the base 61. When so placed, the foot 62 prevents the stand 10 from slipping on a surface.

In operation, a user places the computer 11 on the platter 20 with the bottom 12 of the computer 11 flush against the upper surface 24 of the platter 20. The wings 31, together with the arm 21, assist the user in centrally locating the computer 11 on the platter 20; because the wings 31 and the arm 21 turn upwardly at the outer edge 30 of the platter 20, they are clearly visible, and the user may easily position the computer 11 centrally between the wings 31 and the arm 21. This prevents the computer 11 from being placed off-center, which could cause erratic rotation or instability.

The user places the computer 11 such that the back panel 14 is oriented toward the arm 21. The lower portion 36 of the arm 21 is arcuate and corresponds to the curved housing 13 of the computer 11 below the back panel 14. As such, when the computer 11 is properly centered on the platter 20 and the back panel 14 is properly oriented toward the arm 21, the lip 17 below the back panel 14 is registered with the arm 21 and may be in contact with it. The pocket 18 on the computer 11 between the lip 16 and the back panel 14 is open and ready to receive the clip 22.

The user places the clip 22 simultaneously on the mount 35 of the arm 21 and over the lip 16 of the back panel 14. The upper portion 49 of the clip 50 is placed on the mount 35, with the catch 50 slipped into the pocket 18. The catch 50 thus extends in a downward direction toward the platter 20 and is spaced apart from the arm 21 by the space 54. The lip 16 of the computer 11 is received in the space 54, as shown in FIG. 5B, and occupies the space 54 between the catch 50 and the arm 21. The catch 50 thus overlaps the lip 16 of the back panel 14 and is received in the pocket 18.

With the clip 22 properly applied, the user next secures the clip 22. The user picks up the cable lock 23, such as by hand, and registers it above the mount 35 and the clip 22. The user applies the pin 60 of the cable lock 23 through the hole 52 of the clip 22 and the hole 40 of the arm 21, which are aligned, and then actuates the cable lock 23 with a key, thereby locking the clip 22 securely to the arm 21. The clip 22 is secured on the mount 35 and prevented from vertical movement by the mount 35 and the cable lock 23. The clip 22 is prevented from lateral movement with respect to the mount 35 by engagement of the tabs 55 against the end 56 and the sides of the mount 35.

In this locked configuration, the computer 11 is clamped and locked to the stand 10 and cannot be moved off the stand 10 in any direction. The platter 20 supports the bottom 12 of the computer 11 and prevents downward movement of the computer 11. The lip 16 is retained in the space 54, and the upper portion 49 of the clip 22 above the lip 16 prevents upward movement of the computer 11 away from the platter 20. The catch 50 received in the pocket 18 prevents forward lateral movement of the computer 11 away from the arm 21, and the arm 21 prevents rearward lateral movement of the computer 11. The catch 50 also prevents the computer from moving laterally in a side-to-side fashion across the platter 20. Therefore, the computer 11 is secured between the clip 22, the platter 20, and the arm 21 such that it cannot be removed from the stand 10 without unlocking the cable lock 23.

To bundle the cables 15 with the computer 11, the user runs the cables 15 from the back panel 14 of the computer 11 through the guide loops 42 by sliding the cables through the openings 46, as shown in FIG. 4. The arm 21, formed to the platter 20, rotates together with the platter 20, and thus carries the cables 15 with the arm 21 and the platter 20 in rotation. In this way, when the platter 20 is rotated on the base 61, the cables 15 are retained within the guide loops 42 so that they do not wrap around the computer 11 and become a tangled and unsightly mess.

The computer 11 is removed from the stand 10 by reversing the above procedure. The cable lock 23 is unlocked and removed from the clip 22. The clip 22 is pulled off of the mount 35. The computer 11 is then available to be freely removed from the stand 10.

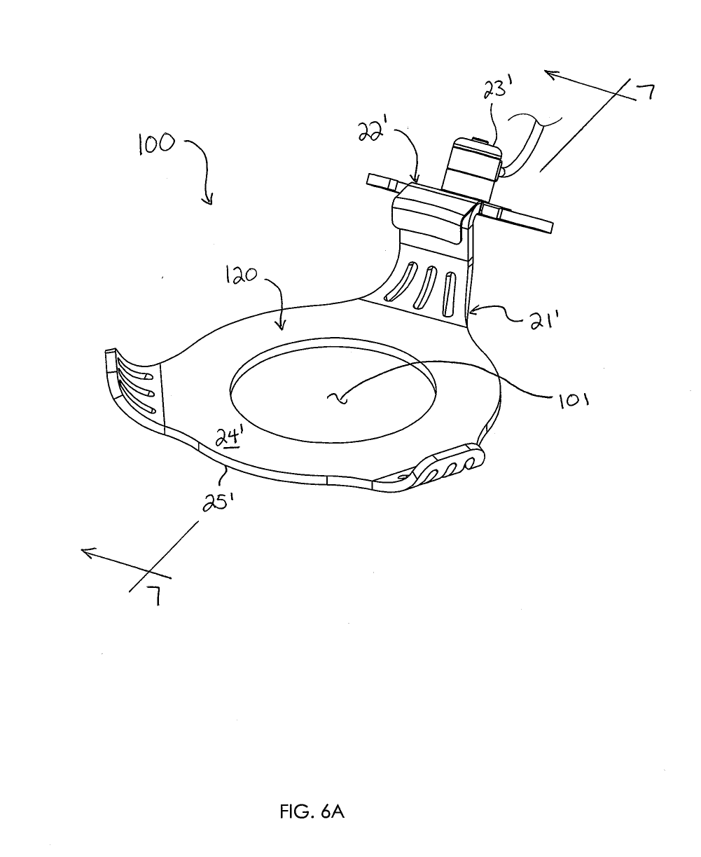

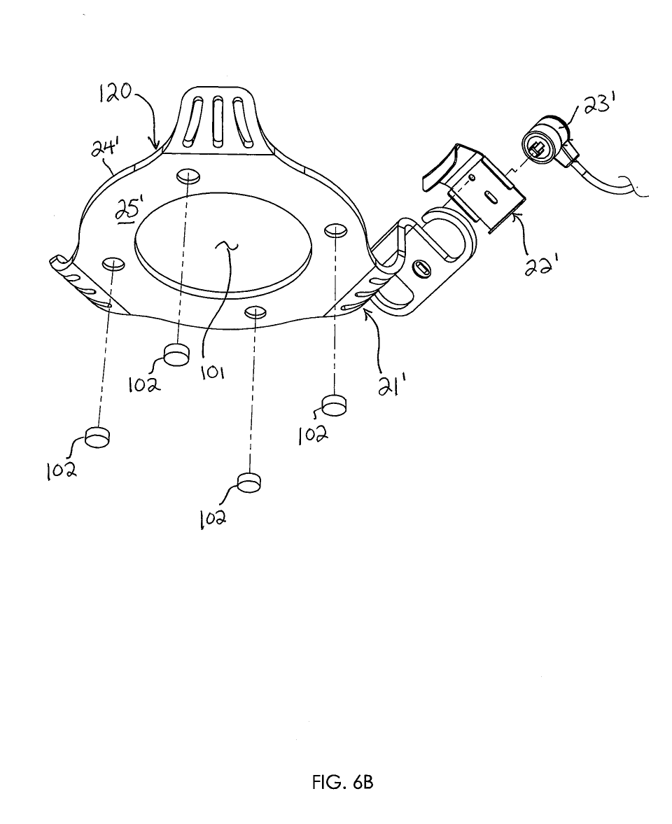

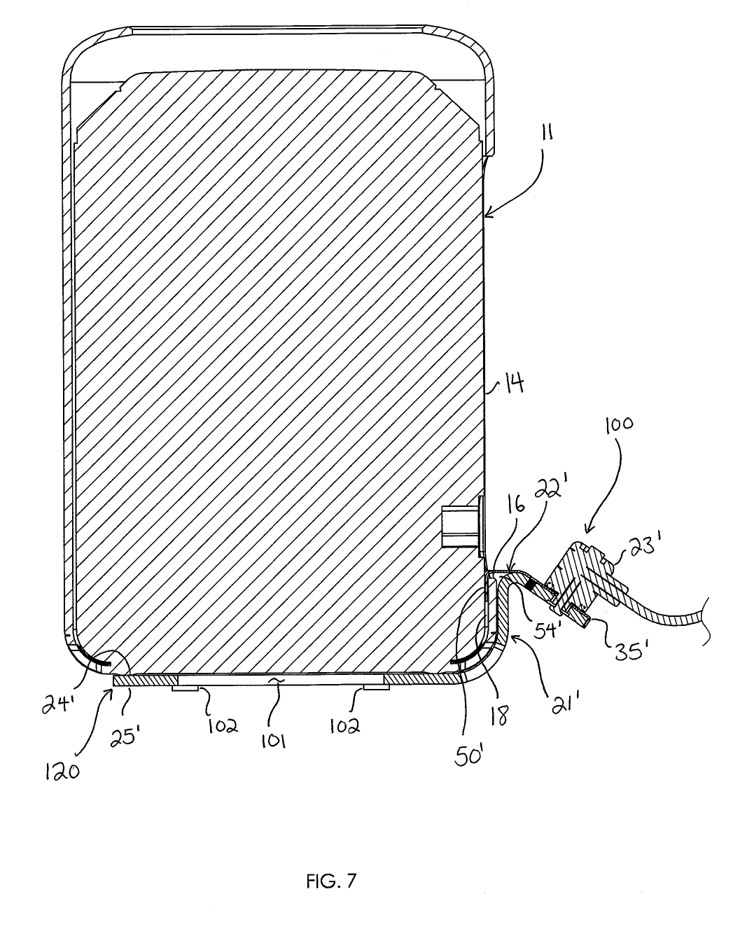

FIGS. 6A, 6B, and 7 illustrate an alternate embodiment of a locking computer stand 100. The stand 100 includes many of the same structural elements and features as the stand 10. Those structural elements and features of the stand 100 which are the same as corresponding structural elements and features in stand are marked with identical reference characters, but are designated with a prime (“′”) symbol to distinguish them from those of stand 10. One having ordinary skill in the art will readily appreciate that each structural element and feature marked with a reference character designated with the prime symbol is identical to the corresponding structural element and feature marked with the same reference character without the prime symbol, except as specifically described herein. As such, many identical structural elements and features are not referenced in the drawings; one having ordinary skill in the art will readily appreciate that the drawings for the stand 10 adequately illustrate such structural elements and features as necessary for understanding.

Like the stand 10, the stand 100 includes a platter 120, an arm 21′ extending from the platter 120, and a clip 22′ releasably coupled to the arm 21′. The clip 22′ is configured to overlap the lip 16 of the computer 11 and can be locked to the arm 21′ by a key-operated cable lock 23′, as with the stand 10. Thus, the computer 11 is held between the clip 22′ and the platter 120, and the clip 22′ is locked in place by the cable lock 23′, which can be secured to a heavy or stable object in the environment such as a desk to prevent the computer from being carried away.

The platter 120 is similar to the platter 20 of the stand 10 with some exceptions. The platter 120 is a thin, generally annular structure with a large central opening 101. The platter 120 includes an annular, flat, and smooth upper surface 24′ around the opening 101, and an opposed coextensive annular lower surface 25′. The opening 101 provides a cooling area for the computer 11 where air may circulate. The opening 101 is approximately half of the diameter of the outer edge 30 and is coaxial to the outer edge 30. Four circumferentially-spaced apart plastic or rubber feet 102 are mounted to the lower surface 25′ of the platter 120, preferably with adhesive. The feet 102 prevent the platter 120 from sliding on a surface, thereby providing stability to the stand 100.

FIG. 7 is a section view taken along the line 7-7 in FIG. 6A showing the stand 100 with the computer 11 applied thereto and secured therein. As with the stand 10, cable lock 23′ is locked to the clip 22′ and the mount 35′, the lip 16 is secured in the space 54′, the catch 50′ is secured in the pocket 18, and the computer 11 is prevented from removal from the stand 100.

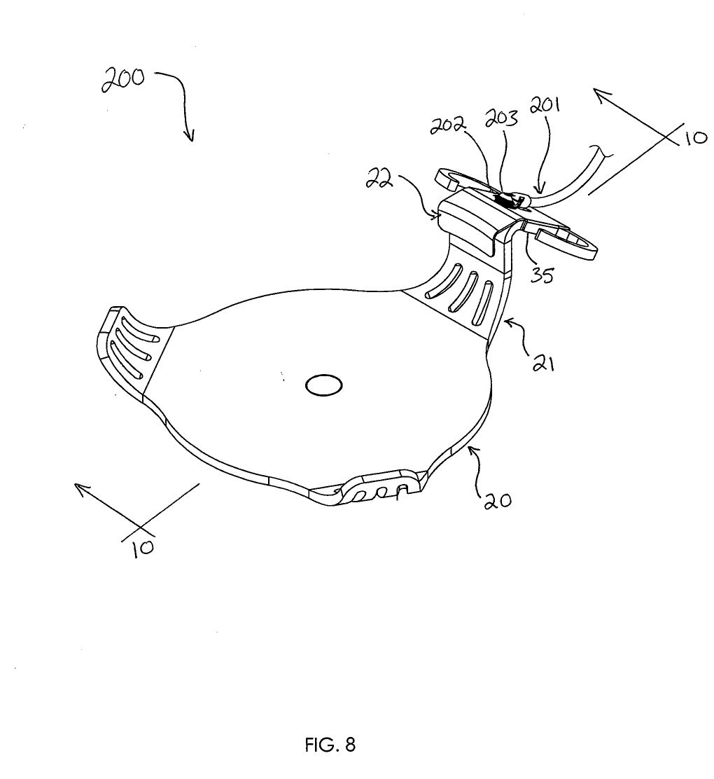

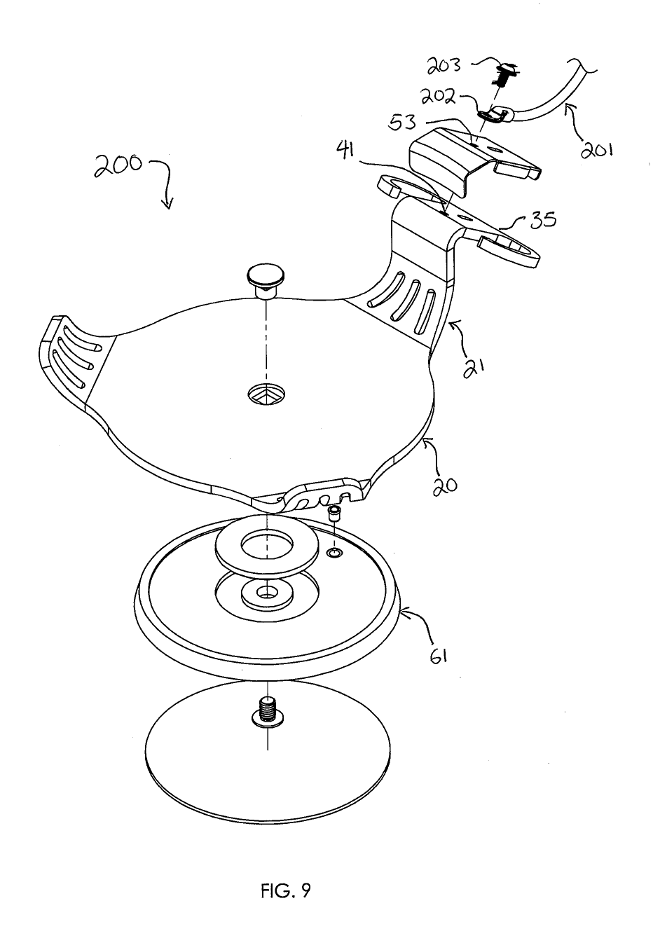

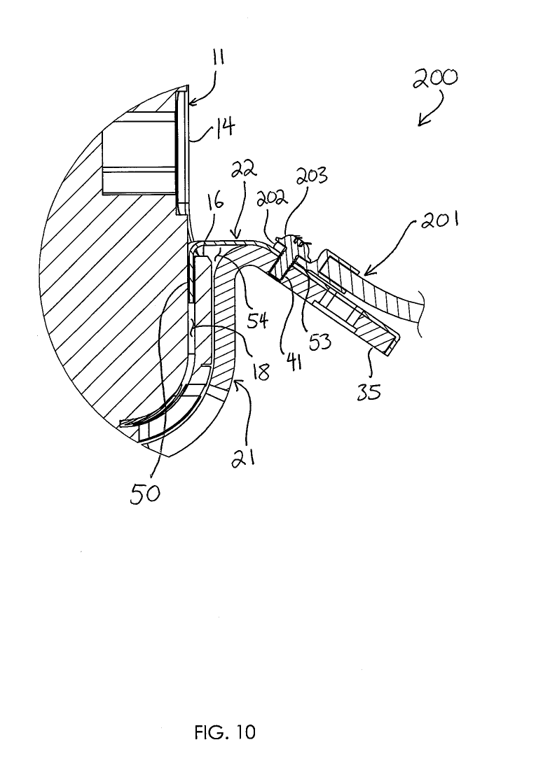

FIGS. 8, 9, and 10 illustrate an alternate embodiment of a locking computer stand 200. The stand 200 is virtually identical to the stand 10 except the stand 200 includes a cable lock 201 that differs from the cable lock 23. As such, the same reference characters are used to identify the same structural elements and features in both the stand 10 and the stand 200. The stand 200 includes the platter 20 mounted for rotation on the base 61, the arm 21 extending from the platter 20, and the clip 22 releasably coupled to the arm 21. However, the clip 22 is coupled to the arm 21 by the cable lock 201. The cable lock 201 is a cable which terminates in an eyelet 202. The eyelet is secured to the clip 22 and the mount 35 with a screw 203. The eyelet 202 has a circular interior hole that corresponds in diameter to the screw 203 to allow the screw 203 to be applied through the eyelet 202. The stand 200 is operated identically to the stand 10, except for operation of the cable lock 201. As such, when operating the stand 200, the user aligns the eyelet 202 over the holes 53 and 41, which are threaded, and inserts the screw 203 through the eyelet 202 and into the holes 53 and 41. The user then rotates the screw 203 to threadably engage the screw 203 with the holes 53 and 41 and tighten the eyelet 202 against the clip 22 and the clip 22 against the arm 21. Thus, the stand 200 is secured to the cable lock 201 and cannot be moved without unscrewing the screw 203. FIG. 10 is an enlarged section view taken along the line 10-10 in FIG. 8, showing the computer 11 on the stand 200, with the cable lock 201 secured to the clip 22 and the mount 35.

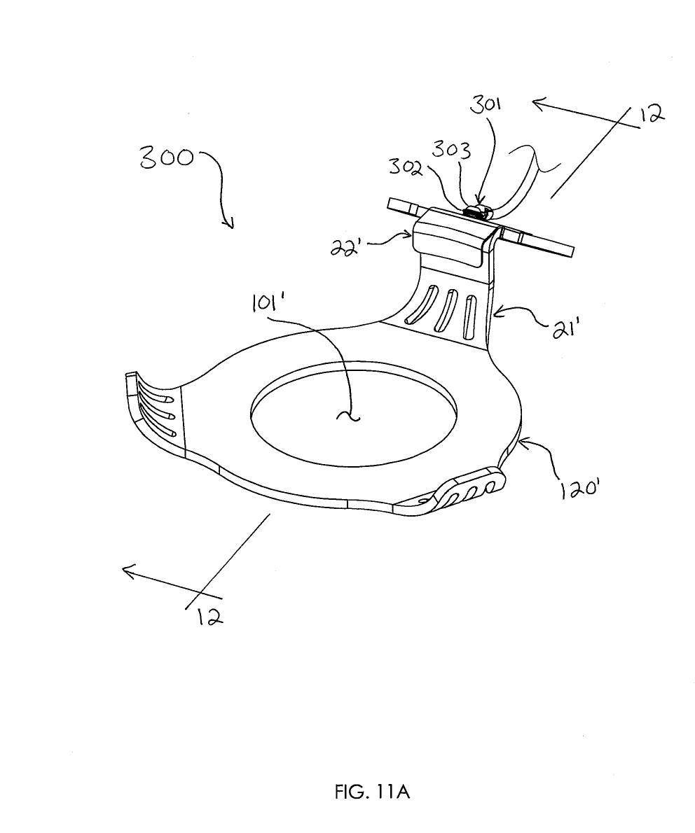

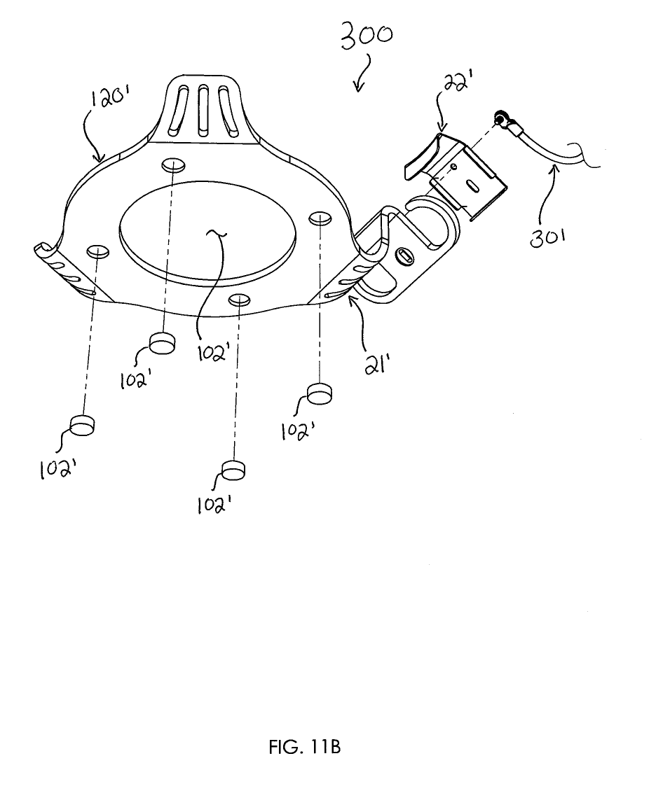

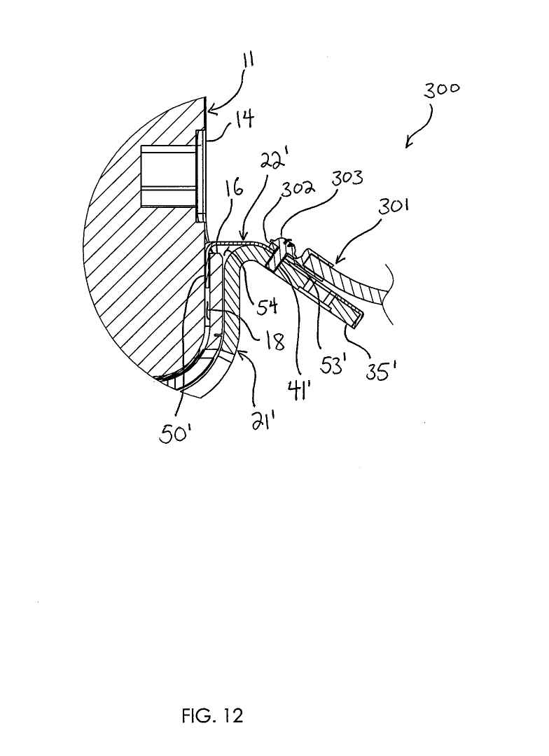

FIGS. 11A, 11B, and 12 show an alternate embodiment of a locking computer stand 300. The stand 300 is virtually identical to the stand 100 and includes nearly all of the same structural elements and features of the stand 100. As such, the same reference characters are used, and are still designated with the prime (“′”) symbol to distinguish them from those of the stand 10. One having ordinary skill in the art will readily appreciate that each structural element and feature marked with a reference character designated with the prime symbol is identical to the corresponding structural element and feature marked with the same reference character without the prime symbol, except as specifically described herein. As such, many identical structural elements and features are not referenced in the drawings; one having ordinary skill in the art will readily appreciate that the drawings for the stand 10 adequately illustrate such structural elements and features as necessary for understanding.

Like the stand 100, the stand 300 includes a platter 120′ with a large central opening 101′ and four feet 102′ on the underside of the platter 120′. The stand 200 further includes an arm 21′ extending from the platter 120′, and a clip 22′ releasably coupled to the arm 21′. The clip 22′ is configured to overlap the lip 16 of the computer 11. The clip 22′ is coupled to the arm 21′ by a cable lock 301. The cable lock 301 is a cable which terminates in an eyelet 302. The eyelet 302 is secured to the clip 22′ and the mount 35′ with a screw 303. The eyelet 302 has a circular interior hole that corresponds in diameter to the screw 303 to allow the screw 303 to be applied through the eyelet 302. The stand 300 is operated identically to the stand 100, except for operation of the cable lock 301. As such, when operating the stand 300, the user aligns the eyelet 302 over the holes 53′ and 41′, which are threaded, and inserts the screw 303 through the eyelet 302 and into the holes 53′ and 41′. The user then rotates the screw 303 to threadably engage the screw 303 with the holes 53′ and 41′ and tighten the eyelet 302 against the clip 22′ and the clip 22′ against the arm 21′. Thus, the stand 300 is secured to the cable lock 301 and cannot be moved without unscrewing the screw 303. FIG. 12 is an enlarged section view taken along the line 12-12 in FIG. 11A, showing the computer 11 on the stand 300, with the cable lock 301 secured to the clip 22′ and the mount 35′.

A preferred embodiment is fully and clearly described above so as to enable one having skill in the art to understand, make, and use the same. Those skilled in the art will recognize that modifications may be made to the described embodiment without departing from the spirit of the invention. To the extent that such modifications do not depart from the spirit of the invention, they are intended to be included within the scope thereof.

The invention claimed is:

1. A stand for holding a desktop computer, the desktop computer including a bottom, a back, and an upstanding lip spaced apart from the back to define a pocket, the stand comprising:
a base;
a platter mounted for rotation to the base, the platter including a flat upper surface configured to receive and support the bottom of the desktop computer thereon, and an outer edge extending around the upper surface;
an arm extending upward from the platter at the outer edge thereof and terminating in a mount; and
a clip releasably secured to the mount, the clip including a catch that extends downward along the arm, defining a space above the platter between the arm and the clip, wherein the catch is configured to overlap the lip of the desktop computer, receive the pocket in the space, and clamp the bottom of the computer against the upper surface of the platter.

2. The stand of claim 1, wherein the outer edge is generally circular.

3. The stand of claim 1, wherein the arm includes a guide loop projecting from the mount on the arm.

4. The stand of claim 3, wherein the guide loop is a severed annulus and extends arcuately from a back of the mount to a free end proximate to a front of the mount.

5. The stand of claim 3, wherein the guide loop and the mount are coplanar.

6. The stand of claim 1, further comprising a spring detent interposed between the base and the platter.

7. The stand of claim 1, further comprising a lock coupling the clip to the mount, the lock threadably fastened through the clip and the mount.

8. The stand of claim 1, further comprising a lock coupling the clip to the mount, the lock releasably fastened through the clip and the mount.

9. A stand for holding a desktop computer, the desktop computer including a bottom, a back, and an upstanding lip spaced apart from the back to define a pocket, the stand comprising:
a platter including a flat upper surface configured to receive and support the bottom of the desktop computer thereon, and a generally circular outer edge extending around the upper surface;
an arm extending upward from the platter at the outer edge thereof and terminating in a mount; and
a clip releasably secured to the mount, the clip including a catch that extends downward along the arm, defining a space above the platter between the arm and the clip, wherein the catch is configured to overlap the lip of the desktop computer, receive the pocket in the space, and clamp the bottom of the computer against the upper surface of the platter.

10. The stand of claim 9, wherein a hole is formed centrally through the platter and is coaxial to the outer edge.

11. The stand of claim 9, wherein the arm includes a guide loop projecting from the mount on the arm, the guide loop comprising a severed annulus extending arcuately from a back of the mount to a free end proximate to a front of the mount.

12. The stand of claim 11, wherein the guide loop and the mount are coplanar.

13. The stand of claim 9, further comprising a lock coupling the clip to the mount, the lock threadably fastened through the clip and the mount.

14. The stand of claim 9, further comprising a lock coupling the clip to the mount, the lock releasably fastened through the clip and the mount.

15. A stand for holding a desktop computer, the desktop computer including a bottom, a back, and an upstanding lip spaced apart from the back to define a pocket, the stand comprising:
a platter including a flat upper surface configured to receive and support the bottom of the desktop computer thereon, and an outer edge extending around the upper surface;
an arm extending upward from the platter at the outer edge thereof and terminating in a mount with a hole formed therein; and
a clip releasably secured to the mount, the clip comprising:
a flat upper portion corresponding in size and shape to the mount, and having a hole formed therein;
a catch extending from the upper portion, the catch oriented transverse with respect to the upper portion;
wherein when the clip is releasably secured to the mount, the hole in the upper portion is aligned with the hole in the mount, and the catch extends downward along the arm, defining a space above the platter between the arm and the clip, and the catch is configured to overlap the lip of the desktop computer, receive the pocket in the space, and clamp the bottom of the computer against the upper surface of the platter.

16. The stand of claim 15, wherein the arm includes a guide loop projecting from the mount on the arm, the guide loop comprising a severed annulus extending arcuately from a back of the mount to a free end proximate to a front of the mount.

17. The stand of claim 15, further comprising a lock coupling the clip to the mount, the lock threadably fastened through the clip and the mount.

18. The stand of claim 15, further comprising a lock coupling the clip to the mount, the lock releasably fastened through the clip and the mount.

19. The stand of claim 15, further comprising a base, wherein the platter is mounted for rotation to the base.

20. The stand of claim 15, further comprising tab on the clip flanking the mount to prevent relative lateral movement of the clip relative the mount.
